(19) United States
(12) Patent Application Publication
(10) Pub. No.: US 2015/0002288 A1
(43) Pub. Date: Jan. 1, 2015

(54) SAFETY DEVICE FOR AUTOMATICALLY ENHANCING LIGHTING AND ALERTING EFFICIENCY WHEN A VEHICLE DOOR IS OPEN

(71) Applicant: Min-Shiou Lee, Taipei City (TW)

(72) Inventor: Min-Shiou Lee, Taipei City (TW)

(21) Appl. No.: 14/052,685

(22) Filed: Oct. 11, 2013

(30) Foreign Application Priority Data
Jun. 28, 2013 (TW) 102212185

(51) Int. Cl. B60Q 1/46

(52) U.S. Cl. CPC B60Q 1/46
USPC 340/471

(57) ABSTRACT

An safety device for automatically enhancing lighting and alerting efficiency when a vehicle door is open includes at least one alert fixing strip arranged on a frame edge of the vehicle door, a plurality of light-emitting elements positioned on the inner side or the outer side or inside of the alert fixing strip, and a sensing switch connected to the light-emitting elements. The sensing switch senses whether the vehicle door is open, and the light-emitting elements illuminate when the vehicle door is open. By arranging the light-emitting elements on the frame edge of the vehicle door, the present invention provides light indication and alertness to other drivers so as to avoid accidents no matter how the vehicle door is opened and what the opened angle is.

### REFERENCE TO RELATED APPLICATIONS

This application claims priority for Taiwan patent application No. 102212185, filed on Jun. 28, 2013, the content of which is herein incorporated by reference in its entirety.

### BACKGROUND OF THE INVENTION

1. Field of the Invention

The present invention relates to a safety alert device, particularly to a safety device for automatically enhancing lighting and alerting efficiency when a vehicle door is open.

2. Description of the Related Art

Whenever a vehicle door is opened at daytime or at night, the opened vehicle door is easily collided by the pedestrian and incoming cars from the rear due to negligence or poor visibility. Furthermore, if the opened door is collided by a motorcycle rider or a bicycle rider, in addition to the property damage, people are also seriously injured during the accident. In order to prevent such accidents, a two-step door opening guideline is set by the ministry of transportation of Taiwan. As a person inside the vehicle is going to get out of the car, he must firstly open the door to leave a slit for watching if there are people or cars coming from the rear of the vehicle. Then he can open the vehicle door to get out of the car if there is no person or cars passing by. This shows the government has put a lot of emphasis on the aforementioned problem that the opened vehicle door is easier collided by the people or cars from the rear. There are some cars which have been provided with welcome lights at the corner of the inner side of the vehicle door or the door shill as the internal lighting devices 30, 32 shown in FIG. 1A. However, the internal lighting devices 30, 32 primarily lighten the areas of the door shill and the walkways. Thus, the light is primarily focused on the internal of the vehicle, not for alerting the drivers of the incoming cars and pedestrians from the rear of the vehicle door. Besides, although the internal lighting devices 30, 32 can be used for indicating position of the vehicle door, they still are not beneficial to warning drivers of the incoming cars and pedestrians from the rear of the vehicle door since the internal lighting devices 30, 32 can be seen neither from the front nor from the back of the vehicle.

As demonstrated in FIG. 1B, for warning the drivers of the incoming cars and pedestrians from the front of the vehicle, it is better to add an external lighting device on the outer side of the vehicle door, such as the external lighting devices 34, 36 in FIG. 1B. The external lighting devices 34, 36 are arranged on the vehicle door and the rearview mirror respectively. As we know, the vehicle door is a rotatable member, and the illumination direction of the external lighting devices 34, 36 may shift during the opening of the vehicle door. Thus, the warning effect is restricted, and there is uncertainty on the warning effect. For example, as the angle between the vehicle door and the vehicle body is 90 degree, the internal lighting devices 30, 32 and the external lighting devices 34, 36 can arise alertness to the drivers of the incoming cars and pedestrians from the front or from the rear of the vehicle so as to avoid colliding onto the opened vehicle door. However, with regard to the lateral side of the vehicle door, the deficiency of the illumination range or the deficiency of the brightness may lead to alertness failure for the drivers or pedestrians. In addition, it is difficult to add the lighting devices and circuits on the vehicle door and the rearview mirror. Thus, the vehicle door must be modified to compile with the internal lighting devices 30, 32 and the external lighting devices 34, 36 shown in FIG. 1A and FIG. 1B which accordingly increases the production complexity.

Accordingly, for compensating the deficiency of the prior art, the present invention provides a safety device for automatically enhancing lighting and alerting efficiency when a vehicle door is open to overcome the abovementioned problems effectively.

### SUMMARY OF THE INVENTION

The primary objective of the present invention is to provide safety device for automatically enhancing lighting and alerting efficiency when a vehicle door is open, which is arranged on a frame edge of a vehicle door. As the vehicle door is open, no matter how the vehicle door is opened and what the opened angle is, the safety device can provide multi-direction light indication and alertness to other drivers and pedestrians for accident prevention.

Another objective of the present invention is to provide a safety device for automatically enhancing lighting and alerting efficiency when a vehicle door is open, in which an alert fixing strip is fixed on a frame edge of a vehicle door by way of adhering, clamping, riveting or fastening The alert fixing strip enclosing the light-emitting elements is disposed along the frame edge of the vehicle door without destroying the vehicle body and the vehicle door.

To achieve the abovementioned objectives, the present invention proposes a safety device for automatically enhancing lighting and alerting efficiency when a vehicle door is open, which is arranged on a vehicle door of a vehicle body. The safety device comprises at least one alert fixing strip, a plurality of light-emitting elements, and a sensing switch. The alert fixing strip is adhesive, clamped, riveted or fastened to a frame edge the vehicle door. The light-emitting elements are arranged on an outer side or an inner side of the alert fixing strip or wrapped inside the alert fixing strip. If the alert fixing strip is opaque, the light-emitting elements are arranged outside the alert fixing strip. If the alert fixing strip is transparent, the light-emitting elements are arranged on the outer side or the inner side of the alert fixing strip or wrapped inside the alert fixing strip. The sensing switch is connected to the light-emitting elements, and senses whether the vehicle door is open via press-controlled sensing or proximity sensing. Then, the light-emitting elements illuminate as the vehicle door is open

### BRIEF DESCRIPTION OF THE DRAWINGS

FIG. 1A and FIG. 1B are diagrams schematically showing a warning light device of the prior art.

FIG. 2A is a three dimensional diagram showing a safety device for automatically enhancing lighting and alerting efficiency when a vehicle door is open according to one embodiment of the present invention.

FIG. 2B is a diagram schematically showing a safety device for automatically enhancing lighting and alerting efficiency when a vehicle door is open according to one embodiment of the present invention.

FIG. 3A is a diagram showing a cross sectional view of a safety device for automatically enhancing lighting and alerting efficiency when a vehicle door is open arranged on the vehicle door according to one embodiment of the present invention.

FIG. 3B is an enlarged diagram schematically showing a part of FIG. 3A.

FIG. 4A and FIG. 4B are diagrams schematically showing a safety device for automatically enhancing lighting and alerting efficiency when a vehicle door is open according to one embodiment of the present invention.

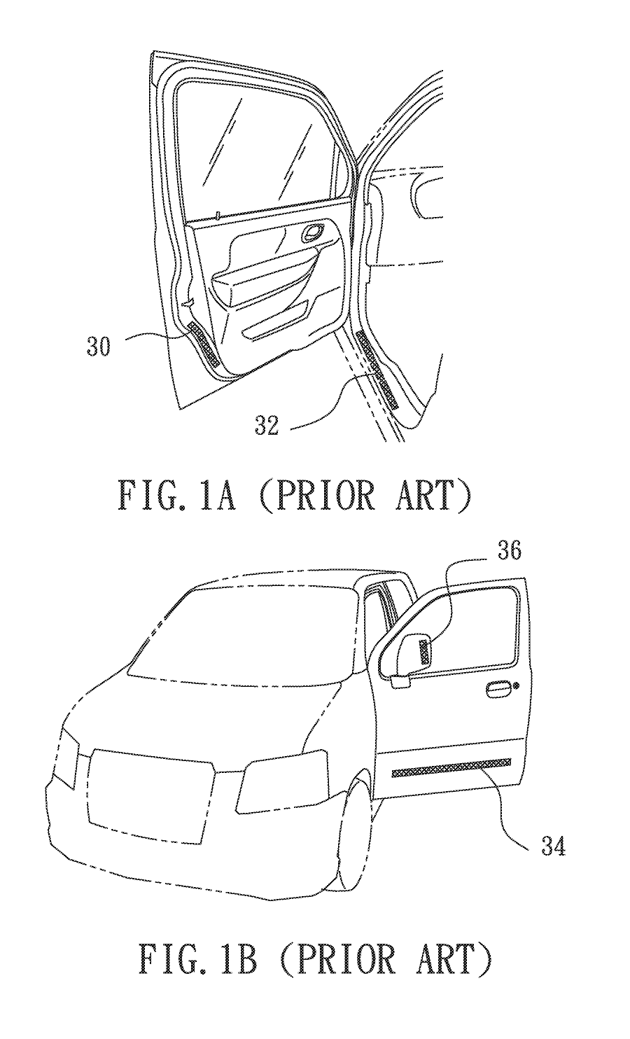

### DETAILED DESCRIPTION OF THE INVENTION

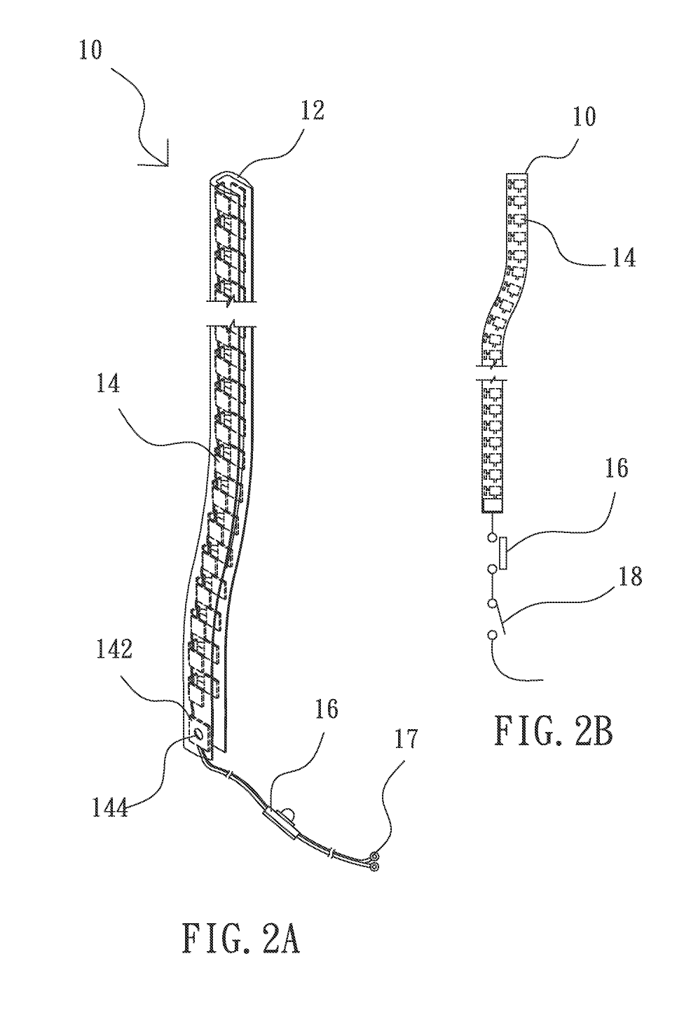

The present invention proposes a safety device for automatically enhancing lighting and alerting efficiency when a vehicle door is open. Refer to FIG. 2A, which is a three dimensional diagram showing a safety device for automatically enhancing lighting and alerting efficiency when a vehicle door is open according to one embodiment of the present invention. The safety device 10 for automatically enhancing lighting and alerting efficiency when a vehicle door is open comprises at least one alert fixing strip 12, a plurality of lighting elements 14, and a sensing switch 16. The alert fixing strip 12 is arranged on a frame edge of a vehicle door. For example, the alert fixing strip 12 may be adhesive to the frame edge or clamped, pasted, riveted or fastened to the frame edge to cover the frame edge of the vehicle door. The light-emitting elements 14 are arranged on an inner side or an outer side of the alert fixing strip 12 or wrapped inside the alert fixing strip 12. The sensing switch 16 is electrically connected to the light-emitting elements 14, and senses whether the vehicle door is open via press-controlled sensing method or proximity sensing method. As a result, the light-emitting elements 14 illuminate when the vehicle door is open.

According to one embodiment of the present invention, the alert fixing strip 12 is a soft, elastic, or flexible strip, which is configured to following the shape and structure of the frame edge of the vehicle door to seamlessly comply with the curve of the edge. In one embodiment, the alert fixing strip 12 can be a single strip arranged on the frame edge of the vehicle door. In other embodiment, the alert fixing strip 12 may also be segmented into parts and then recombined on the frame edge. For example, three alert fixing strips 12 are combined to form a U-shape to clamp onto the frame edge, and are considered as a sealing strip for preventing wind and rain from coming into the vehicle, a shock-absorbing strip for preventing scrap and collision of the vehicle door and the vehicle body, and an insulation strip for sound insulation. The alert fixing strip 12 may be made of a transparent material or an opaque material. When the alert fixing strip 12 is opaque, the light-emitting elements 14 are arranged on the outer side of the alert fixing strip 12. When the alert fixing strip 12 is transparent, the light-emitting elements 14 can be arranged on the outer side, the inner side or directly wrapped inside the alert fixing strip 12. Therefore, light emitted from the light-emitting elements 14 may pass through the alert fixing strip 12 and gives luminance.

In one embodiment, the light-emitting elements 14 can be light-emitting-diodes (LEDs) which comprise many colors to provide alternative and automatic radiance, thus reducing the interference of the background light source, and improving alertness and attention.

The sensing switch 16 can be a proximity sensor or a press controlled switch. When the sensing switch 16 is a proximity sensor and the vehicle door is closed, it is preset that as long as the distance sensed by the proximity sensor is greater than a threshold value, it shows that the vehicle door is not properly closed regardless of the distance between the proximity sensor and the vehicle body. Thus, the vehicle door is determined to be close or not according to the distance between the sensing switch 16 and the vehicle body. When the sensing switch 16 is a press controlled switch, the vehicle door is determined to be close or not according to whether the vehicle door is pressed and touched by the vehicle body.

In addition, the sensing switch 16 is further electrically connected to a circuit of the vehicle body (not shown in figure). The power supply of the sensing switch 16 and the light-emitting elements 14 is the electric power from the vehicle, such as alternating current or direct current. The sensing switch 16 is electrically connected to the circuit of the vehicle body via a connector 17, and the connector 17 can be a plug terminal, a flat cable, or a pin. Meanwhile, please refer to FIG. 2B. The circuit of the vehicle body (not shown in figure) comprises a door latch switch 18 , which is connected to a door latch of the vehicle door for sensing whether the door latch is unlocked or not. As the door latch of the vehicle door is unlocked, the sensing switch 16 determines whether the vehicle door is open. If the vehicle door is close, the light-emitting elements 14 do not illuminate, and if the vehicle door is open, then the light-emitting elements 14 are activated to emit light.

The light-emitting elements 14 are further connected to a driving circuit 142 for triggering the light-emitting elements 14. One end of the driving circuit 142 is connected to the light-emitting elements 14, and the other end of the driving circuit 142 is connected to the sensing switch 16. Besides, the driving circuit 142 further comprises a driving chip 144 for controlling the settings such as luminance, optical chromaticity, static or dynamic illumination, intermittent light flashing, and lighting frequency and period settings of the light-emitting elements 14. The illumination mode can be stable lighting or dynamic lighting, or intermittent flashing Moreover, the driving chip 144 can control the timing and the illumination mode of the light-emitting elements 14 by a remote control device (not shown in figure). Under circumstance like this, the sensing switch 16 is not the key of activating the light-emitting elements 14, but just an interactive media. If the sensing switch 16 senses the vehicle door is close, then the light-emitting elements 14 stop illuminating. If the sensing switch 16 senses the vehicle door is open, then the light-emitting elements 14 can be activated by the remote control device, and the illumination mode of the light-emitting elements 14 can be selected by employing the remote control device. For example, the illumination mode is twinkling at daytime and stops twinkling at night.

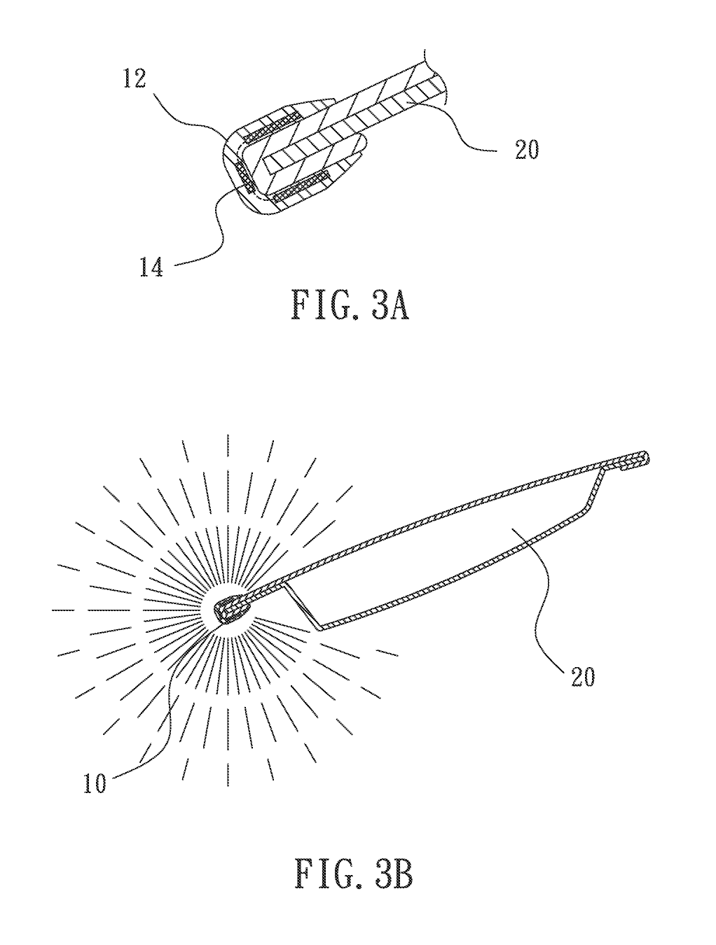

Refer to FIG. 3A, which is a diagram showing a cross sectional view of a safety device for automatically enhancing lighting and alerting efficiency when a vehicle door is open according to one embodiment of the present invention, and FIG. 3B is an enlarged diagram schematically showing a part of FIG. 3A. The alert fixing strip 12 is arranged on the edge of the vehicle door 20 as clearly illustrated in FIG. 3A. In this embodiment, the alert fixing strip 12 is U-shaped and covers the frame edge of the vehicle door 20. Further, in FIG. 3B, it shows that three light-emitting elements 14 each along one direction inside the alert fixing strips 12 are disposed for providing a larger illumination area. No matter how large the angle between the vehicle door 20 and the vehicle body is, light indication can be seen from outside of the vehicle door 20, inside of the vehicle door 20 and lateral of the vehicle door 20. The light-emitting elements 14 in this embodiment are arranged on the inner side of the alert fixing strip 12. Thus, the alert fixing strip 12 must be transparent.

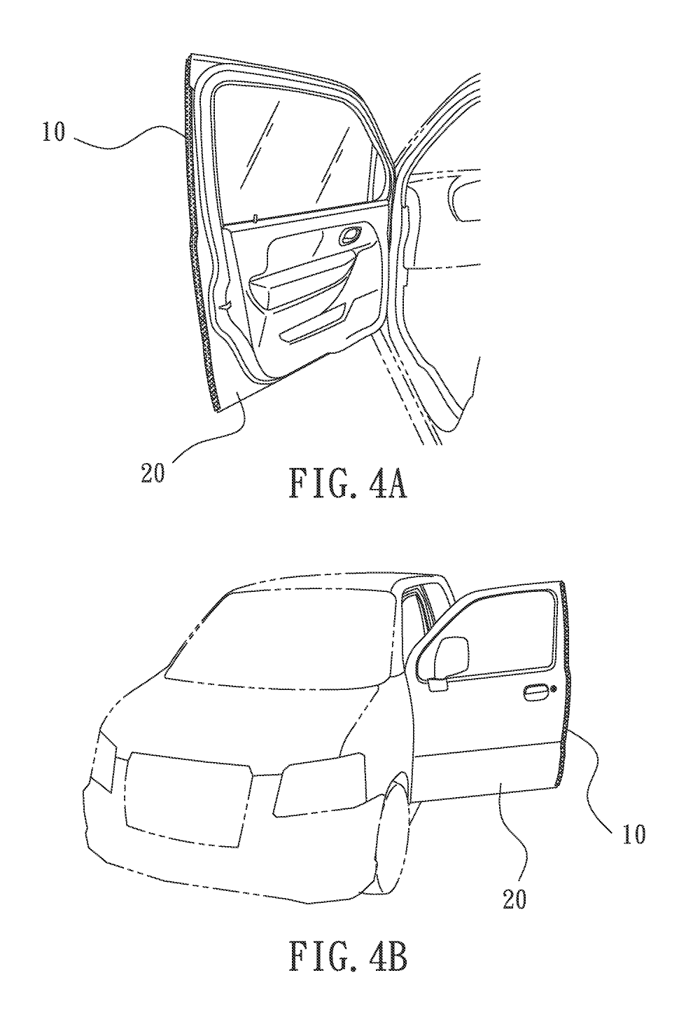

Please refer to FIG. 4A and FIG. 4B together, FIG. 4A and FIG. 4B are diagrams schematically showing a safety device for automatically enhancing lighting and alerting efficiency when a vehicle door is open according to one embodiment of the present invention from different vision angles. When the vehicle door 20 is open, FIG. 4A demonstrates the vision angle from the front of the vehicle, FIG. 4B demonstrates the vision angle from the rear of the vehicle, and the safety device 10 can be clearly seen from the above vision angles. Since the safety device 10 of the present invention is arranged on the frame edge of the vehicle door, it is easier to be combined with the traditional sealing strip for increasing the conventional lighting and alerting, shock-absorbing, and noise isolation efficiency.

In conclusion, the safety device for automatically enhancing lighting and alerting efficiency when a vehicle door is open proposed by the present invention is arranged on the frame edge of the vehicle door, and provides multi-direction light indication as the vehicle door is open, such that the incoming cars and the pedestrians from the front, rear or lateral can notice the opened angle of the vehicle door as the passenger opens the vehicle door, thus preventing and avoiding accidents due to environmental condition such as poor visibility. Poor visibility may be the reason of that the passenger misses his foot as getting out of the car or the incoming car collides to the opened vehicle door. Furthermore, since the alert fixing strip is arranged on the frame edge of the vehicle door, which is similar to the position of the conventional sealing strip, it provides lighting and alerting function without destroying the vehicle body and the vehicle door, and uses multiple light colors, different luminance and intermittent flashing to improve the alertness of others.

The embodiments described above have demonstrated the technical thoughts and characteristics of the present invention, enabling the persons skilled in the art to understand, make, and use the present invention. However, the embodiments are only to exemplify the present invention but not to limit the scope of the present invention. Any equivalent modification or variation according to the spirit of the present invention is to be also included within the scope of the present invention.

What is claimed is:

1. A safety device for automatically enhancing lighting and alerting efficiency when a vehicle door is open, arranged on said vehicle door of a vehicle body, said safety device comprising:
at least one alert fixing strip arranged on a frame edge of said vehicle door;
a plurality of light-emitting elements arranged on said alert fixing strip; and
a sensing switch connected to said light-emitting elements, wherein said sensing switch senses whether said vehicle door is open, and said light-emitting elements illuminate as said vehicle door is open.

2. The safety device according to claim 1, wherein said alert fixing strip is a soft, elastic or flexible strip.

3. The safety device according to claim 1, wherein said light-emitting elements are arranged on an outer side or an inner side of said alert fixing strip or wrapped inside said alert fixing strip.

4. The safety device according to claim 3, wherein when said alert fixing strip is transparent and said light-emitting elements are arranged on said inner side of said alert fixing strip or inside said alert fixing strip, light emitted from said light-emitting elements passes through said alert fixing strip.

5. The safety device according to claim 1, wherein said alert strip is adhesive, clamped, riveted, or fastened to said frame edge of said vehicle door.

6. The safety device according to claim 1, wherein said alert fixing strip is U-shaped and covers said frame edge of said vehicle door.

7. The safety device according to claim 6, wherein said light-emitting elements are arranged on said alert fixing strip and disposed on an inner side, an outer side and an lateral side of said alert fixing strip.

8. The safety device according to claim 1, further comprising a driving circuit connected to said light-emitting elements and said sensing switch for triggering said light-emitting elements.

9. The safety device according to claim 1, wherein said sensing switch is electrically connected to a circuit of said vehicle body which comprises a door latch switch, and said sensing switch determines whether said vehicle door is open as a door latch of said vehicle is unlock.

10. The safety device according to claim 9, wherein said sensing switch is electrically connected to said circuit of said vehicle body via a connector, and said connector is a plug terminal, a flat cable or a pin.

11. The safety device according to claim 1, wherein said sensing switch is a proximity sensor for determining whether said vehicle door is close according to a distance between said sensing switch and said vehicle body.

12. The safety device according to claim 1, wherein said sensing switch is a press controlled switch for determining whether said vehicle door is close according to whether said press controlled switch is pressed.

13. The safety device according to claim 1, wherein said light-emitting elements comprises a plurality of colors to provide alternative and automatic radiance.

14. The safety device according to claim 8, wherein said driving circuit includes a driving chip for controlling luminance, optical chromaticity, static or dynamic illumination, intermittent light flashing, and lighting frequency and period settings of said light-emitting elements.

15. The safety device according to claim 14, wherein said driving chip controls and activates the timing and the illumination mode of said light-emitting elements by a remote control device.

16. The safety device according to claim 1, wherein said light-emitting elements are LEDs.
